(19) United States
(12) Patent Application Publication
(10) Pub. No.: US 2025/0357954 A1
(43) Pub. Date: Nov. 20, 2025

(54) ANTENNA MODULE AND COMMUNICATION DEVICE

(71) Applicant: Murata Manufacturing Co., Ltd., Nagaokakyo-shi (JP)

(72) Inventors: Kenji TAHARA, Nagaokakyo-shi (JP); Kae YAMAMOTO, Nagaokakyo-shi (JP)

(21) Appl. No.: 19/290,412

(22) Filed: Aug. 5, 2025

Related U.S. Application Data
(63) Continuation of application No. PCT/JP2024/002163, filed on Jan. 25, 2024.

(30) Foreign Application Priority Data
Feb. 9, 2023 (JP) 2023-018436

(51) Int. Cl. H04B 1/04; H04B 1/00

(52) U.S. Cl. CPC H04B 1/0458; H04B 1/0053; H04B 1/0067

(57) ABSTRACT

An antenna module includes a patch antenna having feed points, power amplifiers, a transformer having an input-side coil and an output-side coil, and a ¼ wavelength transmission line. An output end of the power amplifier is connected to one end of the input-side coil, an output end of the power amplifier is connected to another end of the input-side coil, one end of the output-side coil is connected to the feed point, another end of the output-side coil is connected to one end of the ¼ wavelength transmission line, and another end of the ¼ wavelength transmission line is connected to the feed point.

### CROSS REFERENCE TO RELATED APPLICATION

This is a continuation of International Application No. PCT/JP2024/002164 filed on Jan. 25, 2024 which claims priority from Japanese Patent Application No. 2023-018436 filed on Feb. 9, 2023. The contents of these applications are incorporated herein by reference in their entireties.

### BACKGROUND OF THE DISCLOSURE

### Field of the Disclosure

The present disclosure relates to an antenna module and a communication device.

### Description of the Related Art

Japanese Unexamined Patent Application Publication No. 2014-165724 discloses a radio transmitter (amplifier) that includes: a first amplifying element and a second amplifying element; an antenna having a first feed point and a second feed point; a first phase shifter connected between an output end of the first amplifying element and the first feed point; a second phase shifter connected between an output end of the second amplifying element and the second feed point; and a power distributor connected to input ends of the first amplifying element and the second amplifying element.

### BRIEF SUMMARY OF THE DISCLOSURE

In the amplifier disclosed in Japanese Unexamined Patent Application Publication No. 2014-165724, the output impedances of the first amplifying element and the second amplifying element fluctuate in response to the fluctuation of the load impedance of the antenna; as a result, the output powers of the first amplifying element and the second amplifying element may fluctuate greatly, thereby causing instability.

The present disclosure has been made in order to solve the above problems, and it is a possible benefit of the present disclosure to provide an antenna module and a communication device having stable output characteristics against load fluctuation.

To achieve the above possible benefit, an antenna module according to an aspect of the present disclosure includes: an antenna having a first feed point and a second feed point; a first power amplifier and a second power amplifier; a first transformer having a first input-side coil and a first output-side coil; and a first impedance conversion circuit. In such an antenna module, an output end of the first power amplifier is connected to one end of the first input-side coil, an output end of the second power amplifier is connected to another end of the first input-side coil, one end of the first output-side coil is connected to the first feed point, another end of the first output-side coil is connected to one end of the first impedance conversion circuit, and another end of the first impedance conversion circuit is connected to the second feed point.

With the present disclosure, it is possible to provide an antenna module and a communication device having stable output characteristics against load fluctuation.

### BRIEF DESCRIPTION OF THE SEVERAL VIEWS OF THE DRAWINGS

FIG. 1 is a configuration diagram of an antenna module and a communication device according to an embodiment.

FIG. 2 is a plan view and a cross-sectional view of a patch antenna according to the embodiment.

FIG. 3 is a circuit state diagram showing the change in impedance with respect to the load fluctuation of the antenna module according to the embodiment.

FIG. 4 is a circuit state diagram showing the change in impedance with respect to the load fluctuation of an antenna module according to a comparative example.

FIG. 5A is a graph showing the relationship between the load impedance, the inter-balance impedance and the VSWR of the antenna module according to the embodiment.

FIG. 5B is a graph showing the relationship between the load impedance, the inter-balance impedance and the VSWR of the antenna module according to the comparative example.

FIG. 6 is a configuration diagram of an antenna module according to Modification 1 of the embodiment.

FIG. 7A is a circuit state diagram showing the change in impedance with respect to a low load impedance of an antenna module according to Modification 2 of the embodiment.

FIG. 7B is a circuit state diagram showing the change in impedance with respect to a high load impedance of the antenna module according to Modification 2 of the embodiment.

FIG. 8 is a configuration diagram of an antenna module according to Modification 3 of the embodiment.

FIG. 9 is a diagram showing circularly polarized antenna characteristics of the antenna module according to the embodiment.

### DETAILED DESCRIPTION OF THE DISCLOSURE

Hereinafter, embodiments of the present disclosure will be described in detail with reference to the drawings. Note that the embodiments described below are all comprehensive or specific examples. The numerical values, shapes, materials, components, arrangement and connection configurations of the components, and the like shown in the following embodiments are merely examples, and are not intended to limit the present disclosure.

It should be noted that each drawing is schematic with emphasis, omissions, or proportions adjusted as appropriate to illustrate the present disclosure, and is not necessarily strictly illustrative, and the shapes, positional relationships, and proportions therein may differ from actual shapes, positional relationships, and proportions. In each drawing, substantially identical components are denoted by the same reference signs, and duplicate descriptions may be omitted or simplified.

In the following drawings, the X-axis and the Y-axis are axes orthogonal to each other on a plane parallel to a main surface of a dielectric substrate. Specifically, when the dielectric substrate has a rectangular shape in plan view, the X-axis is parallel to a first side of the dielectric substrate, and the Y-axis is parallel to a second side orthogonal to the first side of the dielectric substrate. Further, the Z-axis is an axis perpendicular to the main surface of the dielectric substrate, and the positive direction of the Z-axis indicates an upward direction and the negative direction of the Z-axis indicates a downward direction.

In circuit configurations of the present disclosure, the term “connected” includes not only when directly connected by connection terminals and/or wiring conductors, but also when electrically connected via other circuit elements. The expression “connected between A and B” means “connected to both A and B, between A and B”.

In the component arrangement of the present disclosure, the expression “in the plan view” means viewing an object orthographically projected onto the XY plane from the positive side of the Z-axis.

In the present disclosure, the terms indicating relationships between elements, such as “parallel”, “orthogonal” and “distance”, and the terms indicating the shapes of elements, such as “rectangular”, do not represent only strict meanings, but also include substantially equivalent ranges, for example, with errors of several percent. Further, the expression “a first direction is different from a second direction” is defined as a state in which the angle between the direction vector of the first direction and the direction vector of the second direction is not 0 degrees and is not 180 degrees.

Further, in the present disclosure, the term “signal path” means a transmission line composed of a wire through which a high-frequency signal propagates, electrodes directly connected to the wire, terminals directly connected to the wire or the electrodes, and/or the like.

Further, in the present disclosure, the expression “the component (element) A is arranged in series in the path B” means that both the signal input end and the signal output end of the component (element) A are connected to the wire, the electrodes, or the terminals constituting the path B.

Further, in the present disclosure, the phase of a high-frequency signal and the phase difference between two high-frequency signals include errors of several percent. Further, the expression “the phases of two high-frequency signals are opposite to each other” means the phase difference between the two high-frequency signals is substantially 180°, including a case where the phase difference is 180°+several percent.

### Embodiments

### (1. Configuration of Antenna Module 1 and Communication Device 3)

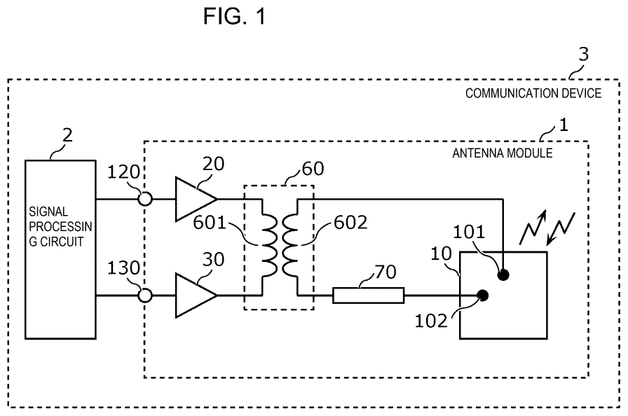

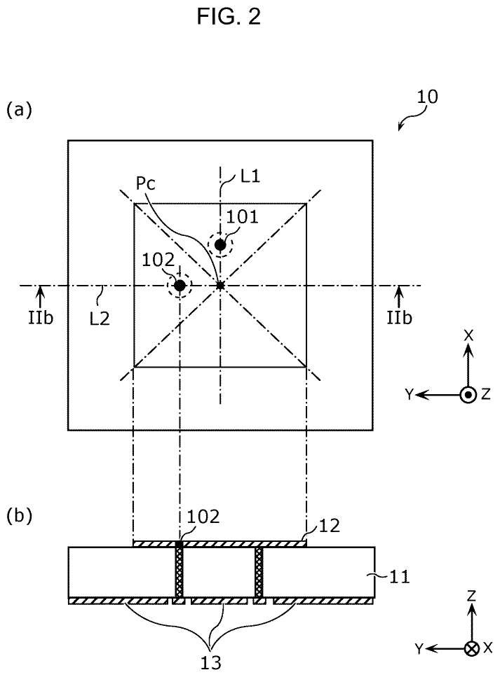

The configuration of an antenna module 1 and a communication device 3 according to an embodiment will be described with reference to FIGS. 1 and 2. FIG. 1 is a configuration diagram of the antenna module 1 and the communication device 3 according to the embodiment. FIG. 2 is a plan view and a cross-sectional view of a patch antenna 10 according to the embodiment.

First, the configuration of the communication device 3 will be described. As shown in FIG. 1, the communication device 3 according to the present embodiment includes the antenna module 1 and a signal processing circuit 2.

The signal processing circuit 2 is an example of a circuit that processes high-frequency signals. The signal processing circuit 2 has a control unit that controls the antenna module 1. Specifically, the signal processing circuit 2 performs signal processing on the transmission signal by up-converting or the like, and outputs a high-frequency transmission signal generated by the signal processing to the antenna module 1. Further, the signal processing circuit 2 controls the power supply voltage and bias currents supplied to respective power amplifiers of the antenna module 1. A part or all of the functions of the control unit of the signal processing circuit 2 may be implemented outside the signal processing circuit 2, for example, in the antenna module 1.

Further, the signal processing circuit 2 outputs, for example, a high-frequency signal to an input terminal 120, and outputs a high-frequency signal obtained by shifting the high-frequency signal outputted to the input terminal 120 by 180° (advanced by 180°) to an input terminal 130. Note that, instead of setting the phase difference of the two high-frequency signals outputted from the signal processing circuit 2 to the antenna module 1 to be 180°, the communication device 3 may be provided with a phase shifting circuit between the signal processing circuit 2 and power amplifiers 20 and 30, the phase shifting circuit dividing one high-frequency signal outputted from the signal processing circuit 2 into two high-frequency signals and setting the phase difference of the two high-frequency signals to be 180°.

The antenna module 1 includes the patch antenna 10, the power amplifiers 20 and 30, a transformer 60, a ¼ wavelength transmission line 70, and the input terminals 120 and 130. The antenna module 1 amplifies the high-frequency signals supplied from the signal processing circuit 2 via the input terminals 120 and 130, and radiates the amplified high-frequency signals from the patch antenna 10.

The power amplifier 20 is an example of a first power amplifier, and is, for example, a power amplifier that amplifies the high-frequency signal inputted via the input terminal 120 and outputs a first high-frequency signal (hereinafter referred to as first signal). The power amplifier 30 is an example of a second power amplifier, and is, for example, a power amplifier that amplifies the high-frequency signal inputted via the input terminal 130 and outputs a second high-frequency signal (hereafter referred to as second signal).

The transformer 60 is an example of a first transformer, and has an input-side coil 601 (first input-side coil) and an output-side coil 602 (first output-side coil).

The ¼ wavelength transmission line 70 is an example of a first impedance conversion circuit. The ¼ wavelength transmission line 70 is a transmission line having a length of ¼ of the wavelength (electric length) of the first signal and the second signal in signal paths connecting the transformer 60 and the patch antenna 10, and is arranged in series in a path connecting the other end of the output-side coil 602 and the patch antenna 10.

The patch antenna 10 is an example of an antenna, and has different feed points 101 (first feed point) and 102 (second feed point).

Note that the antenna module 1 may alternatively be provided with a slot antenna, instead of the patch antenna 10.

The output end of the power amplifier 20 is connected to one end of the input-side coil 601, and the output end of the power amplifier 30 is connected to the other end of the input-side coil 601. Further, one end of the output-side coil 602 is connected to the feed point 101, the other end of the output-side coil 602 is connected to one end of the ¼ wavelength transmission line 70, and the other end of the ¼ wavelength transmission line 70 is connected to the feed point 102.

Note that no ¼ wavelength transmission line is arranged in series in the path connecting one end of the output-side coil 602 and the patch antenna 10. In other words, the path connecting the other end of the output-side coil 602 and the patch antenna 10 is longer than the path connecting one end of the output-side coil 602 and the patch antenna 10 by the length of the ¼ wavelength transmission line 70.

Note that the first impedance conversion circuit does not have to be the ¼ wavelength transmission line 70, but may instead be, for example, an LC circuit that is composed of an inductor and a capacitor and that shifts the phase of the second signal at the other end of the output-side coil 602 by 90°.

With the configuration described above, in the antenna module 1, the phase of the first signal outputted from the power amplifier 20 at one end of the input-side coil 601 and the phase of the second signal outputted from the power amplifier 30 at the other end of the input-side coil 601 are opposite to each other.

Thus, the power amplifiers 20 and 30 become a differential amplifying-type amplifier circuit.

Note that the phase of the first signal at the output end of the power amplifier 20 and the phase of the second signal at the output end of the power amplifier 30 do not have to be opposite to each other; and the phase of the first signal at one end of the input-side coil 601 and the phase of the second signal at the other end of the input-side coil 601 may be opposite to each other by disposing a phase shifting circuit between the output end of the power amplifier 20 and one end of the input-side coil 601 or between the output end of the power amplifier 30 and the other end of the input-side coil 601.

Further, the phase of the first signal outputted from the power amplifier 20 at one end of the input-side coil 601 and the phase of the second signal outputted from the power amplifier 30 at the other end of the input-side coil 601 do not have to be opposite to each other, as long as both phases are different from each other.

Next, the structure of the patch antenna 10 will be described as an example. As shown in FIG. 2, the patch antenna 10 includes, for example, a dielectric substrate 11, a ground conductor 13, and a radiation conductor 12.

The dielectric substrate 11 has a multilayer structure in which a dielectric material is filled between the ground conductor 13 and the radiation conductor 12. Note that the dielectric substrate 11 may also be, for example, a low-temperature co-fired ceramics (LTCC) substrate or a printed circuit board. Further, the dielectric substrate 11 may simply be a space with no dielectric material filled therein. In such a case, a structure for supporting the radiation conductor 12 is required.

The ground conductor 13 is a planar conductor formed on a main surface of the dielectric substrate 11 on the back side (Z-axis negative direction) so as to be substantially parallel to a main surface of the dielectric substrate 11 on the front side (Z-axis positive direction), the ground conductor 13 being set to the ground potential.

The radiation conductor 12 is a planar conductor formed on the main surface of the dielectric substrate 11 on the front side so as to face (substantially parallel to) the ground conductor 13. The main surface on which the radiation conductor 12 is formed and the main surface on which the ground conductor 13 is formed correspond to main surfaces of the patch antenna 10 facing each other.

The first signal outputted from the power amplifier 20 is connected, via the transformer 60, to the feed point 101, which is disposed on the radiation conductor 12 via a feed via conductor formed in the dielectric substrate 11. The second signal outputted from the power amplifier 30 is connected, via the transformer 60 and the ¼ wavelength transmission line 70, to the feed point 102, which is disposed on the radiation conductor 12 via a feed via conductor formed in the dielectric substrate 11.

As shown in FIG. 2, when the main surface (radiation conductor 12) of the patch antenna 10 is viewed in plan view (i.e., viewed from the Z-axis positive side to the negative side), a first direction from a center Pc of the patch antenna 10 toward the feed point 101 is orthogonal to a second direction from the center Pc toward the feed point 102. On the other hand, the phase difference between the first signal inputted to the feed point 101 and the second signal inputted to the feed point 102 is 90°. Thus, the patch antenna 10 can have circularly polarized antenna characteristics.

The center Pc of the patch antenna 10 is defined as the point where the two diagonal lines of the radiation conductor 12 cross when the radiation conductor 12 is viewed in plan view. When the radiation conductor 12 is not rectangular, the center Pc is defined as the center of gravity of the radiation conductor 12.

Note that the positions of the feed points 101 and 102 are not limited to those shown in the part (a) of FIG. 2. It is sufficient that the feed points 101 and 102 is disposed so that the first direction and the second direction are different from each other when the main surface of the patch antenna 10 is viewed in plan view.

With the configuration described above, the antenna module 1 can supply the first signal outputted from the power amplifier 20 and the second signal outputted from the power amplifier 30 to the patch antenna 10 as differential signals.

The antenna module 1 can amplify high-frequency signals in the millimeter wave band and sub-terahertz band inputted from the input terminals 120 and 130. Further, the antenna module 1 can amplify high-frequency signals in a frequency band predefined by a standardization organization or the like (such as 3GPP (registered trademark) (3rd Generation Partnership Project), IEEE (Institute of Electrical and Electronics Engineers), and the like) for a communication system constructed using RAT (radio access technology).

In an antenna module that amplifies high-frequency signals, when a filter or the like is interposed between the output end of an amplifier and a load such as the antenna, fluctuation of the impedance of the amplifier due to fluctuation of the load impedance can be mitigated. In contrast, in an antenna module that amplifies high-frequency signals in the millimeter wave band and sub-terahertz band, the output end of the amplifier is often connected to the load, with no filter or the like provided in between. In such a case, fluctuation of the load impedance directly affects the impedance of the amplifier, and the output power characteristics of the amplifier may become unstable due to fluctuation of the load impedance.

The antenna module 1 according to the present embodiment has a configuration that can stabilize the output power characteristics of the power amplifier even when no filter or the like is provided between the power amplifier and the load.

### (2. Comparison of Impedance Characteristics of Antenna Modules According to Embodiment and Comparative Example)

Next, the impedance characteristics of the antenna module 1 according to the embodiment will be described in comparison with the impedance characteristics of an antenna module 500 according to a comparative example.

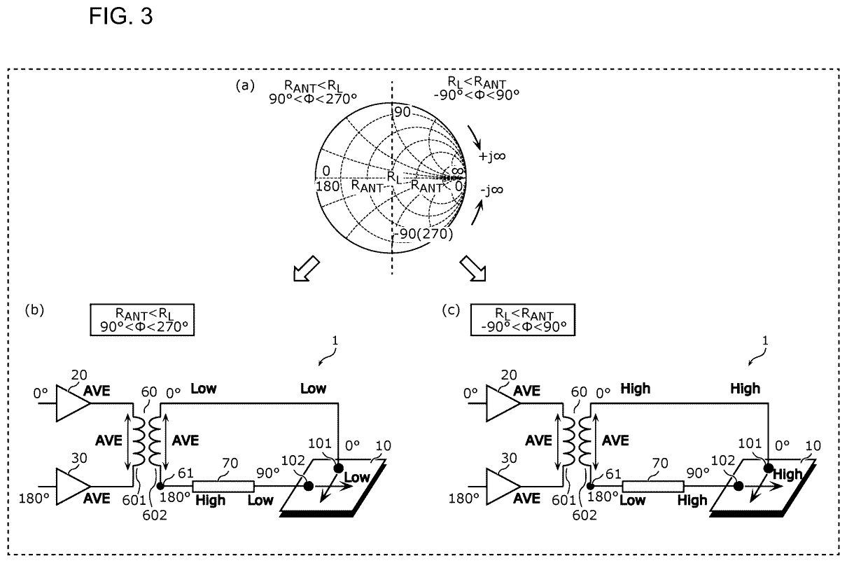

FIG. 3 is a circuit state diagram showing the change in impedance with respect to the load fluctuation of the antenna module 1 according to the embodiment. The part (a) of FIG. 3 is a Smith chart showing the impedance (hereinafter referred to as load impedance R_{ANT}) of the patch antenna 10. The Smith chart of FIG. 3 shows a region (−90°<Φ<90°) where the load impedance R_{ANT} is higher than the reference impedance R_{L}, and a region (90°<Φ<270°) where the load impedance R_{ANT} is lower than the reference impedance R_{L}.

The part (b) of FIG. 3 shows the impedance at each point of the antenna module 1 in a region (Low) where the load impedance R_{ANT} is lower than the reference impedance R_{L}. One end of the output-side coil 602 and the other end of the ¼ wavelength transmission line 70 reflect the load impedance R_{ANT} so as to have a low impedance (Low); and one end of the ¼ wavelength transmission line 70 (hereinafter referred to as an end portion 61) is impedance-converted by the ¼ wavelength transmission line 70 so as to have a high impedance (High).

Thus, since the phase difference between the signals of both ends of the output-side coil 602 is 180°, the inter-balance impedance of the output-side coil 602 defined by the impedance of both ends of the output-side coil 602 is obtained by adding the low impedance (Low) of one end of the output-side coil 602 and the high impedance (High) of the other end (end portion 61) of the output-side coil 602. In other words, the inter-balance impedance of the output-side coil 602 is larger than the low impedance (Low)×2 of one end of the output-side coil 602 and smaller than the high impedance (High)×2 of the other end (end portion 61) of the output-side coil 602, and becomes a so-called averaged impedance (AVE) obtained by averaging the high impedance and the low impedance (=the low impedance (Low) of one end of the output-side coil 602+the high impedance (High) of the other end of the output-side coil 602).

Since the inter-balance impedance of the input-side coil 601 is obtained by converting the inter-balance impedance of the output-side coil 602 at a predetermined conversion ratio of the transformer 60, the inter-balance impedance of the input-side coil 601 also becomes the averaged impedance (AVE) obtained by averaging the high impedance (High) and the low impedance (Low). Since the phase difference between the first signal at the output end of the power amplifier 20 and the second signal at the output end of the power amplifier 30 is 180°, the impedance of the output end of the power amplifier 20 and the impedance of the output end of the power amplifier 30 are each equal to ½ of the inter-balance impedance (AVE) of the input-side coil 601, so that they also become the averaged impedance (AVE) (=½×(the low impedance (Low) of one end of the output-side coil 602+the high impedance (High) of the other end of the output-side coil 602)).

The part (c) of FIG. 3 shows the impedance at each point of the antenna module 1 in a region (High) where the load impedance R_{ANT} is higher than the reference impedance R_{L}. One end of the output-side coil 602 and the other end of the ¼ wavelength transmission line 70 reflect the load impedance R_{ANT} so as to have a high impedance (High); and the end portion 61 is impedance-converted by the ¼ wavelength transmission line 70 so as to have a low impedance (Low).

Thus, since the phase difference between the signals of both ends of the output-side coil 602 is 180°, the inter-balance impedance of the output-side coil 602 defined by the impedance of both ends of the output-side coil 602 is obtained by adding the high impedance (High) of one end of the output-side coil 602 and the low impedance (Low) of the other end (end portion 61) of the output-side coil 602. In other words, the inter-balance impedance of the output-side coil 602 is smaller than the high impedance (High)×2 of one end of the output-side coil 602 and larger than the low impedance (Low)×2 of the other end (end portion 61) of the output-side coil 602, and becomes a so-called averaged impedance (AVE) obtained by averaging the high impedance (High) and the low impedance (Low) (=the high impedance (High) of one end of the output-side coil 602+the low impedance (Low) of the other end of the output-side coil 602).

Since the inter-balance impedance of the input-side coil 601 is obtained by converting the inter-balance impedance of the output-side coil 602 at a predetermined conversion ratio of the transformer 60, the inter-balance impedance of the input-side coil 601 also becomes the averaged impedance (AVE) obtained by averaging the high impedance (High) and the low impedance (Low). Since the phase difference between the first signal at the output end of the power amplifier 20 and the second signal at the output end of the power amplifier 30 is 180°, the impedance of the output end of the power amplifier 20 and the impedance of the output end of the power amplifier 30 are each equal to ½ of the inter-balance impedance (AVE) of the input-side coil 601, so that they also become the averaged impedance (AVE) (=½×(the high impedance (High) of one end of the output-side coil 602+the low impedance (Low) of the other end of the output-side coil 602)).

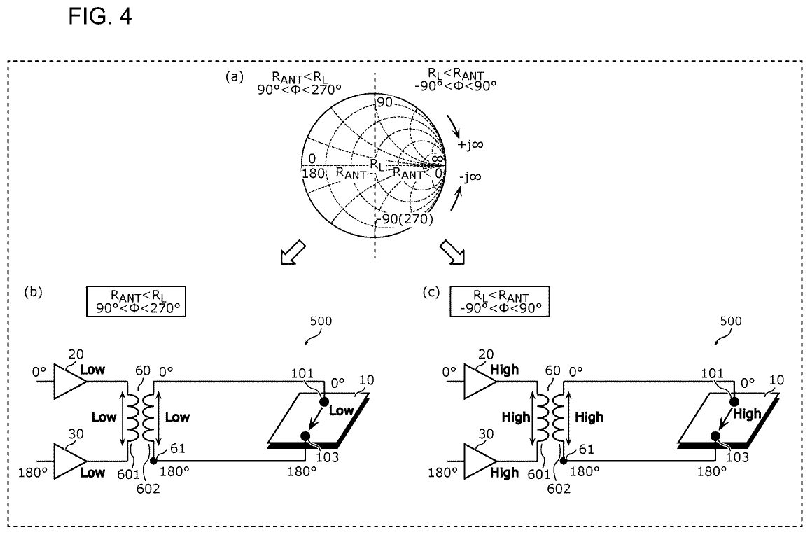

FIG. 4 is a circuit state diagram showing the change in the impedance with respect to the load fluctuation of the antenna module 500 according to the comparative example. The part (a) of FIG. 4 is a Smith chart showing the load impedance R_{ANT} of the patch antenna 10. The Smith chart of FIG. 4 shows a region (−90°<Φ<90°) where the load impedance R_{ANT} is higher than the reference impedance R_{L}, and a region (90°<@<) 270° where the load impedance R_{ANT} is lower than the reference impedance R_{L}.

The antenna module 500 according to the comparative example differs from the antenna module 1 according to the embodiment only in that the ¼ wavelength transmission line 70 is not added.

The part (b) of FIG. 4 shows the impedance at each point of the antenna module 500 in a region (Low) where the load impedance R_{ANT} is lower than the reference impedance R_{L}. Both ends of the output-side coil 602 reflect the load impedance R_{ANT} so as to have a low impedance (Low).

Thus, since the phase difference between the signals of both ends of the output-side coil 602 is 180°, the inter-balance impedance of the output-side coil 602 defined by the impedance of both ends of the output-side coil 602 is obtained by adding the low impedance (Low) at one end of the output-side coil 602 and the low impedance (Low) of the other end (end portion 61) of the output-side coil 602, so that the inter-balance impedance of the output-side coil 602 becomes the low impedance (Low) (=the low impedance (Low) of one end of the output-side coil 602+the low impedance (Low) of the other end of the output-side coil 602).

Since the inter-balance impedance of the input-side coil 601 is obtained by converting the inter-balance impedance of the output-side coil 602 at a predetermined conversion ratio of the transformer 60, the inter-balance impedance of the input-side coil 601 also becomes the low impedance (Low). Since the phase difference between the first signal at the output end of the power amplifier 20 and the second signal at the output end of the power amplifier 30 is 180°, the impedance of the output end of the power amplifier 20 and the impedance of the output end of the power amplifier 30 are each equal to ½ of the inter-balance impedance (Low) of the input-side coil 601, so that they also become the low impedance (Low) (=½×(the Low impedance (Low) of one end of the output-side coil 602+the Low impedance (Low) of the other end of the output-side coil 602)).

The part (c) of FIG. 4 shows the impedance at each point of the antenna module 500 in a region (High) where the load impedance R_{ANT} is higher than the reference impedance R_{L}. Both ends of the output-side coil 602 reflect the load impedance R_{ANT} so as to have a high impedance (High).

Thus, since the phase difference between the signals of both ends of the output-side coil 602 is 180°, the inter-balance impedance of the output-side coil 602 defined by the impedance of both ends of the output-side coil 602 is obtained by adding the high impedance (High) of one end of the output-side coil 602 and the high impedance (High) of the other end (end portion 61) of the output-side coil 602, so that the inter-balance impedance of the output-side coil 602 becomes the high impedance (High) (=the high impedance (High) of one end of the output-side coil 602+the high impedance (High) of the other end of the output-side coil 602).

Since the inter-balance impedance of the input-side coil 601 is obtained by converting the inter-balance impedance of the output-side coil 602 at a predetermined conversion ratio of the transformer 60, the inter-balance impedance of the input-side coil 601 also becomes the high impedance (High). Since the phase difference between the first signal at the output end of the power amplifier 20 and the second signal at the output end of the power amplifier 30 is 180°, the impedance of the output end of the power amplifier 20 and the impedance of the output end of the power amplifier 30 are each equal to ½ of the inter-balance impedance (High) of the input-side coil 601, so that they also become the high impedance (High) (=½×(the high impedance (High) of one end of the output-side coil 602+the high impedance (High) of the other end of the output-side coil 602).

As described above, in the antenna module 500 according to the comparative example, when the load impedance R_{ANT} becomes high, the output impedance of the power amplifiers 20 and 30 becomes relatively high, and when the load impedance R_{ANT} becomes low, the output impedance of the power amplifiers 20 and 30 becomes relatively low. In other words, in the antenna module 500 according to the comparative example, the output impedance of the power amplifiers 20 and 30 greatly fluctuates with respect to the fluctuation of the load impedance R_{ANT}.

In contrast, in the antenna module 1 according to the embodiment, since the transformer 60 and the ¼ wavelength transmission line 70 are added, even if the load impedance R_{ANT} becomes high, the output impedance of the power amplifiers 20 and 30 is the averaged impedance obtained by averaging the high impedance and the low impedance, and even if the load impedance R_{ANT} becomes low, the output impedance of the power amplifiers 20 and 30 is the averaged impedance obtained by averaging the high impedance and the low impedance. In other words, in the antenna module 1 according to the embodiment, the fluctuation of the output impedance of the power amplifiers 20 and 30 is suppressed against the fluctuation of the load impedance R_{ANT}.

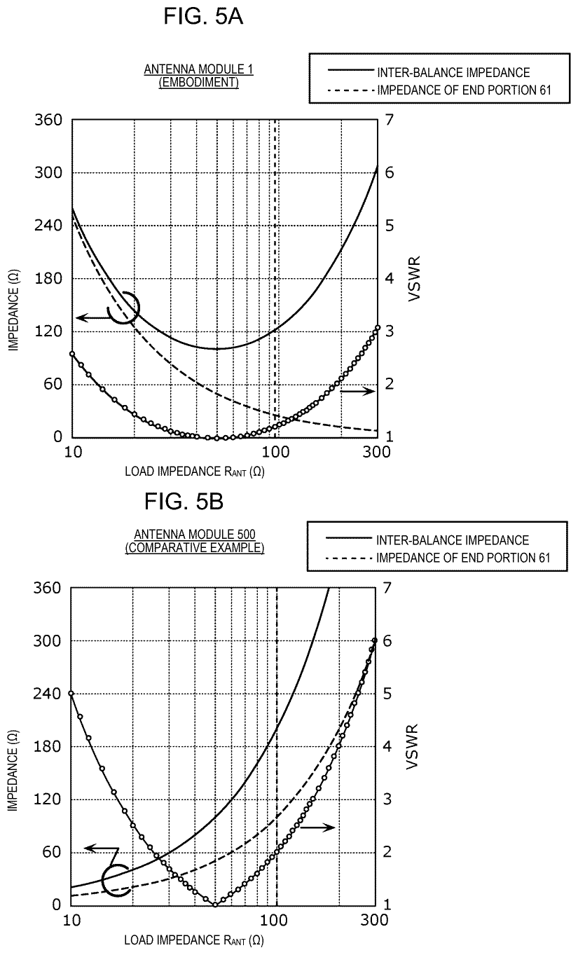

FIG. 5A is a graph showing the relationship between the load impedance R_{ANT}, the inter-balance impedance and the voltage standing wave ratio (VSWR) of the antenna module 1 according to the embodiment. FIG. 5B is a graph showing the relationship between the load impedance R_{ANT}, the inter-balance impedance and the VSWR of the antenna module 500 according to the comparative example. FIGS. 5A and 5B show the impedance of the other end (end portion 61) of the output-side coil 602, the inter-balance impedance of the output-side coil 602, and the VSWR at both ends of the output-side coil 602 when the load impedance R_{ANT} changes in the range of 10Ω to 300Ω.

As shown in FIG. 5B, in the antenna module 500 according to the comparative example, the impedance of the end portion 61 monotonically increases from 10Ω to 300Ω as the load impedance R_{ANT} monotonically increases from 10Ω to 300Ω. Although not shown, the impedance of one end of the output-side coil 602 monotonically increases from 10Ω to 300Ω as the load impedance R_{ANT} monotonically increases from 10Ω to 300Ω. Therefore, since the inter-balance impedance of the output-side coil 602 is obtained by adding the impedance of one end of the output-side coil 602 and the impedance of the other end of the output-side coil 602, it monotonically increases from 20Ω to 600Ω as the load impedance R_{ANT} monotonically increases from 10Ω to 300Ω. Accordingly, the VSWR at both ends of the output-side coil 602 changes from 1 to 5 in the region where the load impedance R_{ANT} is lower than the reference impedance R_{L}, and changes from 1 to 6 in the region where the load impedance R_{ANT} is higher than the reference impedance R_{L}.

In contrast, as shown in FIG. 5A, in the antenna module 1 according to the embodiment, the impedance of the end portion 61 monotonically decreases from 250Ω to 10Ω as the load impedance R_{ANT} monotonically increases from 10Ω to 300Ω. Although not shown, the impedance of one end of the output-side coil 602 monotonically increases from 10Ω to 300Ω as the load impedance R_{ANT} monotonically increases from 10Ω to 300Ω. Therefore, since the inter-balance impedance of the output-side coil 602 is obtained by adding the impedance of one end of the output-side coil 602 and the impedance of the other end of the output-side coil 602, the inter-balance impedance of the output-side coil 602 changes from 250Ω to 100Ω in the region where the load impedance R_{ANT} is lower than the reference impedance R_{L}, and changes from 100Ω to 310Ω in the region where the load impedance R_{ANT} is higher than the reference impedance R_{L}. In other words, the inter-balance impedance of the output-side coil 602 changes from 20Ω to 600Ω in the antenna module 500 according to the comparative example, but changes from 100Ω to 310Ω in the antenna module 1 according to the embodiment, so that the variation of the inter-balance impedance of the output-side coil 602 according to the embodiment is suppressed against the variation of the load impedance R_{ANT}. Accordingly, in the antenna module 1 according to the embodiment, the VSWR at both ends of the output-side coil 602 changes from 1 to 2.5 in the region where the load impedance R_{ANT} is lower than the reference impedance R_{L}, and changes from 1 to 3 in the region where the load impedance R_{ANT} is higher than the reference impedance R_{L}, so that the VSWR is small with respect to the variation of the load impedance R_{ANT} and the variation of the VSWR can be suppressed. Therefore, the antenna module 1 having stable output characteristics against load fluctuation can be provided.

### (3. Configuration of Antenna Module 1A According to Modification 1)

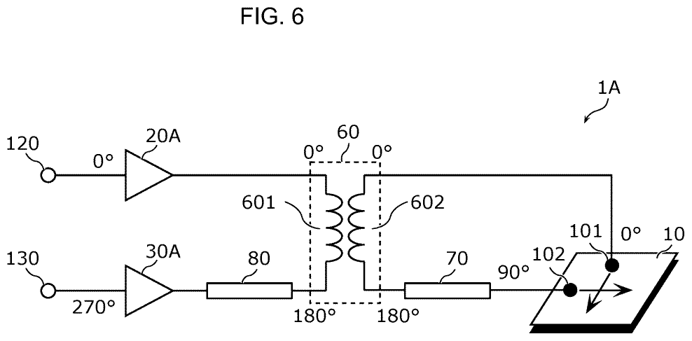

FIG. 6 is a configuration diagram of an antenna module 1A according to Modification 1 of the embodiment. As shown in FIG. 6, the antenna module 1A according to the present modification includes a patch antenna 10, power amplifiers 20A and 30A, a transformer 60, ¼ wavelength transmission lines 70 and 80, and input terminals 120 and 130. The antenna module 1A according to the present modification is different from the antenna module 1 according to the embodiment in that the antenna module 1 according to the embodiment constitutes a differential amplifying-type amplifier circuit, while the antenna module 1A according to the present modification constitutes a Doherty-type amplifier circuit. The antenna module 1A according to the present modification will be described below. In the following description of the antenna module 1A, the same configurations as those of the antenna module 1 according to the embodiment will be omitted, and configurations different from the antenna module 1 will be mainly described.

The power amplifier 20A is an example of the first power amplifier, and is a carrier amplifier. The power amplifier 20A is a class A (or class AB) amplifier circuit capable of performing amplifying operation in regions of all power levels of the high-frequency signal inputted to the power amplifier 20A, particularly capable of performing high-efficiency amplifying operation in a low-output region and a medium-output region. In this description, the term “efficiency” means the power added efficiency.

The power amplifier 30A is an example of the second power amplifier, and is a peak amplifier. The power amplifier 30A is a class C amplifier circuit capable of performing amplifying operation in a region where the power level of the high-frequency signal inputted to the power amplifier 30A is high. Since a bias voltage lower than that applied to the amplifying transistor of the power amplifier 20A is applied to the amplifying transistor of the power amplifier 30A, the higher the power level of the high-frequency signal inputted to the power amplifier 30A, the lower the output impedance. Thus, the power amplifier 30A can perform a low-distortion amplifying operation in a high-output region.

The ¼ wavelength transmission line 80 is an example of a first phase shifting circuit, and is connected between the output end of the power amplifier 30A and the other end of the input-side coil 601. The ¼ wavelength transmission line 80 shifts the phase of the second signal outputted from the power amplifier 30A by 90°.

In the present modification, the signal processing circuit 2 outputs, for example, a high-frequency signal to the input terminal 120, and outputs a high-frequency signal obtained by shifting the high-frequency signal outputted to the input terminal 120 by 270° (advanced by 270°) to the input terminal 130.

Note that no ¼ wavelength transmission line is arranged in series in the path connecting the output end of the power amplifier 20A and one end of the input-side coil 601. In other words, the path connecting the output end of the power amplifier 30A and the other end of the input-side coil 601 is longer than the path connecting the output end of the power amplifier 20A and one end of the input-side coil 601 by the length of the ¼ wavelength transmission line 80.

Note that the first phase shifting circuit does not have to be the ¼ wavelength transmission line 80, but may instead be, for example, an LC circuit that is composed of an inductor and a capacitor and that shifts the phase of the second signal at the other end of the input-side coil 601 by 90°.

With the configuration described above, in the antenna module 1A, the phase of the first signal outputted from the power amplifier 20A at one end of the input-side coil 601 and the phase of the second signal outputted from the power amplifier 30A at the other end of the input-side coil 601 are opposite to each other.

With the configuration described above, it is possible to provide a high-efficiency antenna module 1A having a back-off amount, which is a power difference between a high-output region where the power amplifiers 20A and 30A are in an on-state and a low-output region where only the power amplifier 20A is in an on-state.

Further, in the antenna module 1A according to the present modification, since the transformer 60 and the ¼ wavelength transmission line 70 are added, even if the load impedance R_{ANT} of the patch antenna 10 becomes high, the output impedance of the power amplifiers 20A and 30A becomes an averaged impedance obtained by averaging the high impedance and the low impedance. Further, even if the load impedance R_{ANT} becomes low, the output impedance of the power amplifiers 20A and 30A becomes an averaged impedance obtained by averaging the high impedance and the low impedance. In other words, in the antenna module 1A according to the present modification, the fluctuation of the output impedance of the power amplifiers 20A and 30A is suppressed against the fluctuation of the load impedance R_{ANT}, as in the antenna module 1 according to the embodiment. Therefore, the antenna module 1A having stable output characteristics against load fluctuation can be provided.

Note that, in the antenna module 1A, the power amplifier 20A may alternatively be a peak amplifier and the power amplifier 30A may alternatively be a carrier amplifier. In such a case, the ¼ wavelength transmission line 80 is connected between the power amplifier 20A and one end of the input-side coil 601, and no ¼ wavelength transmission line is arranged in series in the path connecting the output end of the power amplifier 30A and the other end of the input-side coil 601.

Further, the phase of the first signal outputted from the power amplifier 20A at one end of the input-side coil 601 and the phase of the second signal outputted from the power amplifier 30A at the other end of the input-side coil 601 do not have to be opposite to each other, as long as both phases are different from each other.

### (4. Configuration of Antenna Module 1B According to Modification 2)

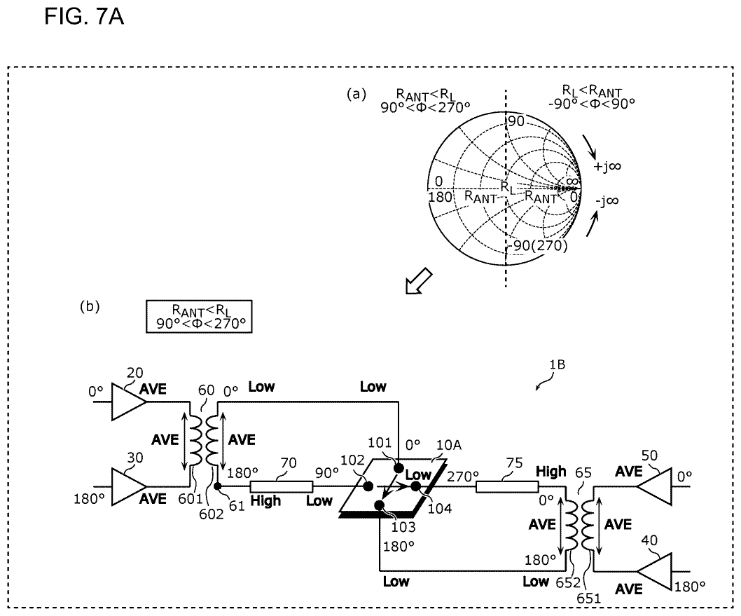

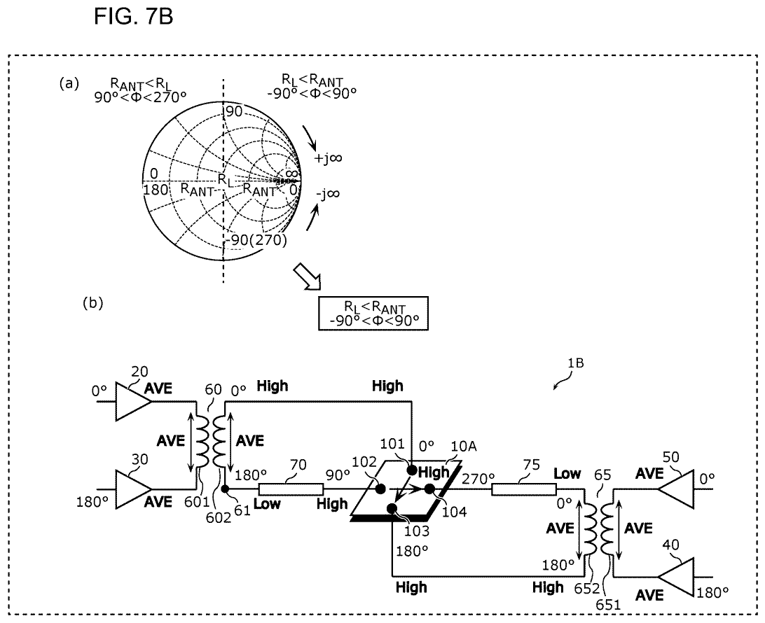

FIG. 7A is a circuit state diagram showing the change in impedance with respect to a low load impedance of an antenna module 1B according to Modification 2 of the embodiment. FIG. 7B is a circuit state diagram showing the change in impedance with respect to a high load impedance of the antenna module 1B according to Modification 2 of the embodiment. As shown in FIGS. 7A and 7B, the antenna module 1B according to the present modification includes a patch antenna 10A, power amplifiers 20, 30, 40 and 50, transformers 60 and 65, and ¼ wavelength transmission lines 70 and 75. The antenna module 1B according to the present modification is different from the antenna module 1 according to the embodiment in that the antenna module 1 according to the embodiment is configured to supply two high-frequency signals having a phase difference of 90° to the patch antenna 10 having two feed points, while the antenna module 1B according to the present modification is configured to supply four high-frequency signals having a phase difference of 90° to the patch antenna 10A having four feed points. The antenna module 1B according to the present modification will be described below. In the following description of the antenna module 1B, the same configurations as those of the antenna module 1 according to the embodiment will be omitted, and configurations different from the antenna module 1 will be mainly described.

The power amplifier 40 is an example of a third power amplifier, and is, for example, a power amplifier that amplifies the high-frequency signal outputted from the signal processing circuit 2 and outputs a third high-frequency signal (hereafter referred to as third signal). The power amplifier 50 is an example of a fourth power amplifier, and is, for example, a power amplifier that amplifies the high-frequency signal outputted from the signal processing circuit 2 and outputs a fourth high-frequency signal (hereafter referred to as fourth signal).

In the present modification, the signal processing circuit 2 outputs, for example, a high-frequency signal to the input end of the power amplifier 20, and outputs a high-frequency signal obtained by shifting the high-frequency signal outputted to the input end of the power amplifier 20 by 180° (advanced by 180°) to the input end of the power amplifier 30. Further, the signal processing circuit 2 outputs, for example, a high-frequency signal obtained by shifting the high-frequency signal outputted to the input end of the power amplifier 20 by 180° (advanced by 180°) to the input end of the power amplifier 40, and outputs a high-frequency signal obtained by shifting the high-frequency signal outputted to the input end of the power amplifier 40 by −180° (delayed by 180°) to the input end of the power amplifier 50.

The antenna module 1B amplifies the high-frequency signal outputted from the signal processing circuit 2, and radiates the amplified high-frequency signal from the patch antenna 10A.

The transformer 65 is an example of a second transformer, and has an input-side coil 651 (second input-side coil) and an output-side coil 652 (second output-side coil).

The ¼ wavelength transmission line 75 is an example of a second impedance conversion circuit. The ¼ wavelength transmission line 75 is a transmission line having a length of ¼ of the wavelength (electric length) of the third signal and the fourth signal in signal paths connecting the transformer 65 and the patch antenna 10A, and is arranged in series in a path connecting the other end of the output-side coil 652 and the patch antenna 10A.

The patch antenna 10A has different feed points 101 (first feed point), 102 (second feed point), 103 (third feed point), and 104 (fourth feed point).

The output end of the power amplifier 40 is connected to one end of the input-side coil 651, and the output end of the power amplifier 50 is connected to the other end of the input-side coil 651. Further, one end of the output-side coil 652 is connected to the feed point 103, the other end of the output-side coil 652 is connected to one end of the ¼ wavelength transmission line 75, and the other end of the ¼ wavelength transmission line 75 is connected to the feed point 104.

Note that no ¼ wavelength transmission line is arranged in series in the path connecting one end of the output-side coil 652 and the patch antenna 10A. In other words, the path connecting the other end of the output-side coil 652 and the patch antenna 10A is longer than the path connecting one end of the output-side coil 652 and the patch antenna 10A by the length of the ¼ wavelength transmission line 75.

Note that the second impedance conversion circuit does not have to be the ¼ wavelength transmission line 75, but may instead be, for example, an LC circuit that is composed of an inductor and a capacitor and that shifts the phase of the fourth signal at the other end of the output-side coil 652 by 90°.

With the configuration described above, in the antenna module 1B, the phase of the first signal outputted from the power amplifier 20 at one end of the input-side coil 601 and the phase of the second signal outputted from the power amplifier 30 at the other end of the input-side coil 601 are opposite to each other. Further, the phase of the third signal outputted from the power amplifier 40 at one end of the input-side coil 651 and the phase of the fourth signal outputted from the power amplifier 50 at the other end of the input-side coil 651 are opposite to each other.

Thus, the power amplifiers 20 and 30 constitute a differential amplifying-type amplifier circuit, and the power amplifiers 40 and 50 constitute a differential amplifying-type amplifier circuit.

Note that the phase of the first signal at the output end of the power amplifier 20 and the phase of the second signal at the output end of the power amplifier 30 do not have to be opposite to each other; and the phase of the first signal at one end of the input-side coil 601 and the phase of the second signal at the other end of the input-side coil 601 may be opposite to each other by disposing a phase shifting circuit between the output end of the power amplifier 20 and one end of the input-side coil 601 or between the output end of the power amplifier 30 and the other end of the input-side coil 601. Further, the phase of the third signal at the output end of the power amplifier 40 and the phase of the fourth signal at the output end of the power amplifier 50 do not have to be opposite to each other; and the phase of the third signal at one end of the input-side coil 651 and the phase of the fourth signal at the other end of the input-side coil 651 may be opposite to each other by disposing a phase shifting circuit between the output end of the power amplifier 40 and one end of the input-side coil 651 or between the output end of the power amplifier 50 and the other end of the input-side coil 651.

Further, the phase of the first signal outputted from the power amplifier 20 at one end of the input-side coil 601 and the phase of the second signal outputted from the power amplifier 30 at the other end of the input-side coil 601 do not have to be opposite to each other, as long as both phases are different from each other. Further, the phase of the third signal outputted from the power amplifier 40 at one end of the input-side coil 651 and the phase of the fourth signal outputted from the power amplifier 50 at the other end of the input-side coil 651 do not have to be opposite to each other, as long as both phases are different from each other.

The cross-sectional structure of the patch antenna 10A is the same as that of the patch antenna 10 according to the embodiment. The first signal outputted from the power amplifier 20 is connected to the feed point 101. The second signal outputted from the power amplifier 30 is connected to the feed point 102 via the transformer 60 and the ¼ wavelength transmission line 70. The third signal outputted from the power amplifier 40 is connected to the feed point 103. The fourth signal outputted from the power amplifier 50 is connected to the feed point 104 via the transformer 65 and the ¼ wavelength transmission line 75.

When the main surface of the patch antenna 10A is viewed in plan view, a first direction from the center Pc toward the feed point 101 is orthogonal to a second direction from the center Pc toward the feed point 102, the second direction is orthogonal to a third direction from the center Pc toward the feed point 103, the third direction is orthogonal to a fourth direction from the center Pc toward the feed point 104, the fourth direction is orthogonal to the first direction, the first direction is opposite to the third direction, and the second direction is opposite to the fourth direction.

With such a configuration, the patch antenna 10A can have circularly polarized antenna characteristics by setting the phase difference between the first signal inputted to the feed point 101 and the second signal inputted to the feed point 102 to be 90°, the phase difference between the second signal inputted to the feed point 102 and the third signal inputted to the feed point 103 to be 90°, the phase difference between the third signal inputted to the feed point 103 and the fourth signal inputted to the feed point 104 to be 90°, and the phase difference between the fourth signal inputted to the feed point 104 and the first signal inputted to the feed point 101 to be 90°.

The positions of the feed points 101, 102, 103 and 104 are not limited to the positional relationship described above. It is sufficient that the feed points 101 to 104 are disposed so that, when the main surface of the patch antenna 10A is viewed in plan view, the first direction and the second direction are different from each other, the second direction and the third direction are different from each other, the third direction and the fourth direction are different from each other, the fourth direction and the first direction are different from each other, the first direction is opposite to the third direction, and the second direction is opposite to the fourth direction.

The part (a) of FIG. 7A is a Smith chart showing the impedance (hereinafter referred to as load impedance R_{ANT}) Of the patch antenna 10A. The Smith chart of FIG. 7A shows a region (−90°<Φ<90°) where the load impedance R_{ANT} is higher than the reference impedance R_{L}, and a region (90°<Φ<270°) where the load impedance R_{ANT} is lower than the reference impedance R_{L}.

The part (b) of FIG. 7A shows the impedance at each point of the antenna module 1B in a region (Low) where the load impedance R_{ANT} is lower than the reference impedance R_{L}. One end of the output-side coil 602 and the other end of the ¼ wavelength transmission line 70 reflect the load impedance R_{ANT} so as to have a low impedance (Low); and one end of the ¼ wavelength transmission line 70 is impedance-converted by the ¼ wavelength transmission line 70 so as to have a high impedance (High).

Thus, since the phase difference between the signals of both ends of the output-side coil 602 is 180°, the inter-balance impedance of the output-side coil 602 defined by the impedance of both ends of the output-side coil 602 is obtained by adding the low impedance (Low) of one end of the output-side coil 602 and the high impedance (High) of the other end of the output-side coil 602. In other words, the inter-balance impedance of the output-side coil 602 is larger than the low impedance (Low)×2 of one end of the output-side coil 602 and smaller than the high impedance (High)×2 of the other end of the output-side coil 602, and becomes an averaged impedance (AVE) obtained by averaging the high impedance and the low impedance.

Since the inter-balance impedance of the input-side coil 601 is obtained by converting the inter-balance impedance of the output-side coil 602 at a predetermined conversion ratio of the transformer 60, the inter-balance impedance of the input-side coil 601 also becomes the averaged impedance (AVE) obtained by averaging the high impedance (High) and the low impedance (Low). Since the phase difference between the first signal at the output end of the power amplifier 20 and the second signal at the output end of the power amplifier 30 is 180°, the impedance of the output end of the power amplifier 20 and the impedance of the output end of the power amplifier 30 are each equal to ½ of the inter-balance impedance (AVE) of the input-side coil 601, so that they also become the averaged impedance (AVE).

Further, one end of the output-side coil 652 and the other end of the ¼ wavelength transmission line 75 reflect the load impedance R_{ANT} so as to have a low impedance (Low); and one end of the ¼ wavelength transmission line 75 is impedance-converted by the ¼ wavelength transmission line 75 so as to have a high impedance (High).

Thus, since the phase difference between the signals of both ends of the output-side coil 652 is 180°, the inter-balance impedance of the output-side coil 652 defined by the impedance of both ends of the output-side coil 652 is obtained by adding the low impedance (Low) of one end of the output-side coil 652 and the high impedance (High) of the other end of the output-side coil 602. In other words, the inter-balance impedance of the output-side coil 652 is larger than the low impedance (Low)×2 of one end of the output-side coil 652 and smaller than the high impedance (High)×2 of the other end of the output-side coil 652, and becomes an averaged impedance (AVE) obtained by averaging the high impedance and the low impedance.

Since the inter-balance impedance of the input-side coil 651 is obtained by converting the inter-balance impedance of the output-side coil 652 at a predetermined conversion ratio of the transformer 65, the inter-balance impedance of the input-side coil 651 also becomes the averaged impedance (AVE) obtained by averaging the high impedance (High) and the low impedance (Low). Since the phase difference between the third signal at the output end of the power amplifier 40 and the fourth signal at the output end of the power amplifier 50 is 180°, the impedance of the output end of the power amplifier 40 and the impedance of the output end of the power amplifier 50 are each equal to ½ of the inter-balance impedance (AVE) of the input-side coil 651, so that they also become the averaged impedance (AVE).

In other words, in the region (Low) where the load impedance R_{ANT} is lower than the reference impedance R_{L}, the impedance of the output end of the power amplifier 20, the impedance of the output end of the power amplifier 30, the impedance of the output end of the power amplifier 40, and the impedance of the output end of the power amplifier 50 are each the averaged impedance (AVE).

The part (a) of FIG. 7B is a Smith chart showing the impedance (hereinafter referred to as load impedance R_{ANT}) Of the patch antenna 10A. The Smith chart of FIG. 7B shows a region (−90°<Φ<90°) where the load impedance R_{ANT} is higher than the reference impedance R_{L}, and a region (90°<Φ<270°) where the load impedance R_{ANT} is lower than the reference impedance R_{L}.

The part (b) of FIG. 7B shows the impedance at each point of the antenna module 1B in a region (High) where the load impedance R_{ANT} is higher than the reference impedance R_{L}. One end of the output-side coil 602 and the other end of the ¼ wavelength transmission line 70 reflect the load impedance R_{ANT} so as to have a high impedance (High); and one end of the ¼ wavelength transmission line 70 is impedance-converted by the ¼ wavelength transmission line 70 so as to have a low impedance (Low).

Thus, since the phase difference between the signals of both ends of the output-side coil 602 is 180°, the inter-balance impedance of the output-side coil 602 defined by the impedance of both ends of the output-side coil 602 is obtained by adding the high impedance (High) of one end of the output-side coil 602 and the low impedance (Low) of the other end of the output-side coil 602. In other words, the inter-balance impedance of the output-side coil 602 is smaller than the high impedance (High)×2 of one end of the output-side coil 602 and larger than the low impedance (Low)×2 of the other end of the output-side coil 602, and becomes a so-called averaged impedance (AVE) obtained by averaging the high impedance and the low impedance.

Since the inter-balance impedance of the input-side coil 601 is obtained by converting the inter-balance impedance of the output-side coil 602 at a predetermined conversion ratio of the transformer 60, the inter-balance impedance of the input-side coil 601 also becomes the averaged impedance (AVE) obtained by averaging the high impedance (High) and the low impedance (Low). Since the phase difference between the first signal of the output end of the power amplifier 20 and the second signal of the output end of the power amplifier 30 is 180°, the impedance of the output end of the power amplifier 20 and the impedance of the output end of the power amplifier 30 are each equal to ½ of the inter-balance impedance (AVE) of the input-side coil 601, so that they also become the averaged impedance (AVE).

Further, one end of the output-side coil 652 and the other end of the ¼ wavelength transmission line 75 reflect the load impedance R_{ANT} so as to have a high impedance (High); and one end of the ¼ wavelength transmission line 75 is impedance-converted by the ¼ wavelength transmission line 75 so as to have a low impedance (Low).

Thus, since the phase difference between the signals of both ends of the output-side coil 652 is 180°, the inter-balance impedance of the output-side coil 652 defined by the impedance of both ends of the output-side coil 652 is obtained by adding the high impedance (High) of one end of the output-side coil 652 and the low impedance (Low) of the other end of the output-side coil 602. In other words, the inter-balance impedance of the output-side coil 652 is smaller than the high impedance (High)×2 of one end of the output-side coil 652 and larger than the low impedance (Low)×2 of the other end of the output-side coil 652, and becomes a so-called averaged impedance (AVE) obtained by averaging the high impedance and the low impedance.

Since the inter-balance impedance of the input-side coil 651 is obtained by converting the inter-balance impedance of the output-side coil 652 at a predetermined conversion ratio of the transformer 65, the inter-balance impedance of the input-side coil 651 also becomes the averaged impedance (AVE) obtained by averaging the high impedance (High) and the low impedance (Low). Since the phase difference between the third signal at the output end of the power amplifier 40 and the fourth signal at the output end of the power amplifier 50 is 180°, the impedance of the output end of the power amplifier 40 and the impedance of the output end of the power amplifier 50 are each equal to ½ of the inter-balance impedance (AVE) of the input-side coil 651, so that they also become the averaged impedance (AVE).

In other words, in a region (High) where the load impedance R_{ANT} is higher than the reference impedance R_{L}, the impedance of the output end of the power amplifier 20, the impedance of the output end of the power amplifier 30, the impedance of the output end of the power amplifier 40, and the impedance of the output end of the power amplifier 50 are each the averaged impedance (AVE).

It is known from the above that in the antenna module 1B, since the transformers 60 and 65 and the ¼ wavelength transmission lines 70 and 75 are added, even if the load impedance R_{ANT} becomes high, the output impedance of the power amplifiers 20 to 50 is the averaged impedance, and even if the load impedance R_{ANT} becomes low, the output impedance of the power amplifiers 20 to 50 is the averaged impedance. In other words, in the antenna module 1B according to the present modification, the fluctuation of the output impedance of the power amplifiers 20 to 50 is suppressed against the fluctuation of the load impedance R_{ANT}. Therefore, the antenna module 1B having stable output characteristics against load fluctuation can be provided.

### (5. Configuration of Antenna Module 1C According to Modification 3)

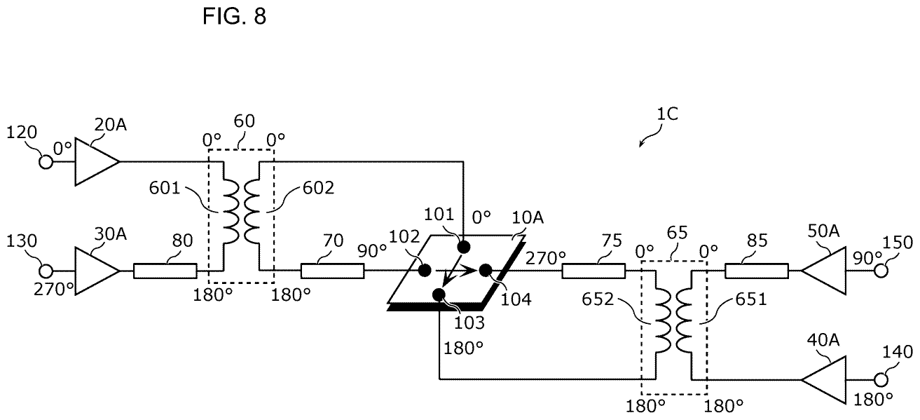

FIG. 8 is a configuration diagram of an antenna module 1C according to Modification 3 of the embodiment. As shown in FIG. 8, the antenna module 1C according to the present modification includes a patch antenna 10A, power amplifiers 20A, 30A, 40A and 50A, transformers 60 and 65, ¼ wavelength transmission lines 70, 75, 80 and 85, and input terminals 120, 130, 140 and 150. The antenna module 1C according to the present modification is different from the antenna module 1B according to Modification 2 in that the antenna module 1B according to Modification 2 constitutes a differential amplifying-type amplifier circuit, while the antenna module 1C according to the present modification constitutes a Doherty-type amplifier circuit. Hereinafter, the same configurations of the antenna module 1C according to the present modification as those of the antenna module 1B according to Modification 2 will be omitted, and configurations different from the antenna module 1B according to Modification 2 will be mainly described.

The power amplifier 20A is an example of the first power amplifier, and is a carrier amplifier. The power amplifier 20A is a class A (or class AB) amplifier circuit capable of performing amplifying operation in regions of all power levels of the high-frequency signal inputted to the power amplifier 20A, particularly capable of performing high-efficiency amplifying operation in a low-output region and a medium-output region.

The power amplifier 30A is an example of the second power amplifier, and is a peak amplifier. The power amplifier 30A is a class C amplifier circuit capable of performing amplifying operation in a region where the power level of the high-frequency signal inputted to the power amplifier 30A is high. Since a bias voltage lower than that applied to the amplifying transistor of the power amplifier 20A is applied to the amplifying transistor of the power amplifier 30A, the higher the power level of the high-frequency signal inputted to the power amplifier 30A, the lower the output impedance. Thus, the power amplifier 30A can perform a low-distortion amplifying operation in a high-output region.

The power amplifier 40A is an example of the third power amplifier, and is a carrier amplifier. The power amplifier 40A is a class A (or class AB) amplifier circuit capable of performing amplifying operation in regions of all power levels of the high-frequency signal inputted to the power amplifier 40A, particularly capable of performing high-efficiency amplifying operation in a low-output region and a medium-output region.

The power amplifier 50A is an example of the fourth power amplifier, and is a peak amplifier. The power amplifier 50A is a class C amplifier circuit capable of performing amplifying operation in a region where the power level of the high-frequency signal inputted to the power amplifier 50A is high. Since a bias voltage lower than that applied to the amplifying transistor of the power amplifier 40A is applied to the amplifying transistor of the power amplifier 50A, the higher the power level of the high-frequency signal inputted to the power amplifier 50A, the lower the output impedance. Thus, the power amplifier 50A can perform a low-distortion amplifying operation in a high-output region.

The ¼ wavelength transmission line 80 is an example of the first phase shifting circuit, and is connected between the output end of the power amplifier 30A and the other end of the input-side coil 601. The ¼ wavelength transmission line 80 shifts the phase of the second signal outputted from the power amplifier 30A by 90°.

The ¼ wavelength transmission line 85 is an example of a second phase shifting circuit, and is connected between the output end of the power amplifier 50A and the other end of the input-side coil 651. The ¼ wavelength transmission line 85 shifts the phase of the fourth signal outputted from the power amplifier 50A by 90°.

In the present modification, the signal processing circuit 2 outputs, for example, a high-frequency signal to the input terminal 120, and outputs a high-frequency signal obtained by shifting the high-frequency signal outputted to the input terminal 120 by 270° (advanced by 270°) to the input terminal 130. Further, the signal processing circuit 2 outputs, for example, a high-frequency signal obtained by shifting the high-frequency signal outputted to the input terminal 120 by 180° (advanced by 180°) to an input terminal 140, and outputs a high-frequency signal obtained by shifting the high-frequency signal outputted to the input terminal 140 by −90° (advanced by 270°) to an input terminal 150.

Note that no ¼ wavelength transmission line is arranged in series in the path connecting the output end of the power amplifier 20A and one end of the input-side coil 601. In other words, the path connecting the output end of the power amplifier 30A and the other end of the input-side coil 601 is longer than the path connecting the output end of the power amplifier 20A and one end of the input-side coil 601 by the length of the ¼ wavelength transmission line 80.

Further, no ¼ wavelength transmission line is arranged in series in the path connecting the output end of the power amplifier 40A and one end of the input-side coil 651. In other words, the path connecting the output end of the power amplifier 50A and the other end of the input-side coil 651 is longer than the path connecting the output end of the power amplifier 40A and one end of the input-side coil 651 by the length of the ¼ wavelength transmission line 85.

Note that the first phase shifting circuit does not have to be the ¼ wavelength transmission line 80, but may instead be, for example, an LC circuit that is composed of an inductor and a capacitor and that shifts the phase of the second signal at the other end of the input-side coil 601 by 90°. The second phase shifting circuit does not have to be the ¼ wavelength transmission line 85, but may instead be, for example, an LC circuit that is composed of an inductor and a capacitor and that shifts the phase of the fourth signal at the other end of the input-side coil 651 by 90°.

With the configuration described above, in the antenna module 1C, the phase of the first signal outputted from the power amplifier 20A at one end of the input-side coil 601 and the phase of the second signal outputted from the power amplifier 30A at the other end of the input-side coil 601 are opposite to each other. Further, the phase of the third signal outputted from the power amplifier 40A at one end of the input-side coil 651 and the phase of the fourth signal outputted from the power amplifier 50A at the other end of the input-side coil 651 are opposite to each other.

With the configuration described above, it is possible to provide a high-efficiency antenna module 1C having a back-off amount, which is a power difference between a high-output region where the power amplifiers 20A and 30A are in an on-state and a low-output region where only the power amplifier 20A is in an on-state, and a back-off amount, which is a power difference between a high-output region where the power amplifiers 40A and 50A are in an on-state and a low-output region where only the power amplifier 40A is in an on-state.

In the antenna module 1C according to the present modification, since the transformer 60 and the ¼ wavelength transmission line 70 are added, even if the load impedance R_{ANT} of the patch antenna 10A becomes high, the output impedance of the power amplifiers 20A and 30A becomes an averaged impedance obtained by averaging the high impedance and the low impedance. Also, even if the load impedance R_{ANT} of the patch antenna 10A becomes high, the output impedance of the power amplifiers 40A and 50A becomes an averaged impedance obtained by averaging the high impedance and the low impedance. Further, even if the load impedance R_{ANT} becomes low, the output impedance of the power amplifiers 20A and 30A becomes an averaged impedance obtained by averaging the high impedance and the low impedance. Also, even if the load impedance R_{ANT} becomes low, the output impedance of the power amplifiers 40A and 50A becomes an averaged impedance obtained by averaging the high impedance and the low impedance. In other words, in the antenna module 1C according to the present modification, the fluctuation of the output impedance of the power amplifiers 20A to 50A is suppressed against the fluctuation of the load impedance R_{ANT}, as in the antenna module 1B according to Modification 2. Therefore, the antenna module 1C having stable output characteristics against load fluctuation can be provided.

Note that, in the antenna module 1C, the power amplifier 20A may alternatively be a peak amplifier and the power amplifier 30A may alternatively be a carrier amplifier. In such a case, the ¼ wavelength transmission line 80 is connected between the power amplifier 20A and one end of the input-side coil 601, and no ¼ wavelength transmission line is arranged in series in the path connecting the output end of the power amplifier 30A and the other end of the input-side coil 601. Also, the power amplifier 40A may alternatively be a peak amplifier and the power amplifier 50A may alternatively be a carrier amplifier. In such a case, the ¼ wavelength transmission line 85 is connected between the power amplifier 40A and one end of the input-side coil 651, and no ¼ wavelength transmission line is arranged in series in the path connecting the output end of the power amplifier 50A and the other end of the input-side coil 651.

### (6. Antenna Characteristics of the Antenna Module 1 According to the Embodiment)

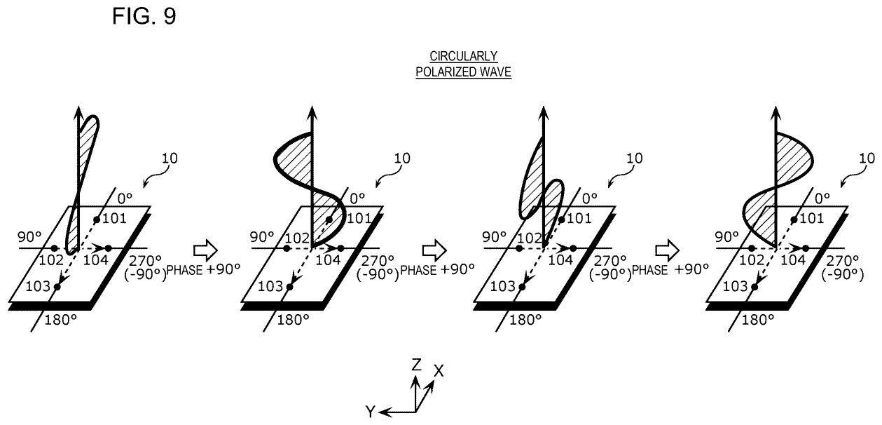

FIG. 9 is a diagram showing circularly polarized antenna characteristics of the antenna module 1 according to the embodiment. As shown in FIG. 9, the antenna module 1 according to the present embodiment realizes so-called circularly polarized antenna characteristics in which the electric and magnetic fields rotate around the Z-axis. This is because the first signal and the second signal having a phase difference of 90° are supplied to the feed points 101 and 102, respectively.

Also, in the antenna module 1A according to Modification 1, the first signal and the second signal having a phase difference of 90° are supplied to the feed points 101 and 102, respectively, so that the circularly polarized antenna characteristics can be realized.

Further, in the antenna module 1B according to Modification 2 and the antenna module 1C according to Modification 3, the phase difference between the first signal and the second signal, the phase difference between the second signal and the third signal, the phase difference between the third signal and the fourth signal, and the phase difference between the fourth signal and the first signal are each 90°, so that circularly polarized antenna characteristics can be realized.

### (7. Effects and the Like)

As described above, the antenna module 1 according to the present embodiment includes: a patch antenna 10 having feed points 101 and 102, power amplifiers 20 and 30; a transformer 60 having an input-side coil 601 and an output-side coil 602; and a ¼ wavelength transmission line 70. An output end of the power amplifier 20 is connected to one end of the input-side coil 601, an output end of the power amplifier 30 is connected to the other end of the input-side coil 601, one end of the output-side coil 602 is connected to the feed point 101, the other end of the output-side coil 602 is connected to one end of the ¼ wavelength transmission line 70, and the other end of the ¼ wavelength transmission line 70 is connected to the feed point 102.

With such a configuration, since the transformer 60 and the ¼ wavelength transmission line 70 are added, even if the load impedance R_{ANT} of the patch antenna 10 is high, the output impedance of the power amplifiers 20 and 30 becomes an averaged impedance obtained by averaging the high impedance and the low impedance, and even if the load impedance R_{ANT} is low, the output impedance of the power amplifiers 20 and 30 becomes the averaged impedance obtained by averaging the high impedance and the low impedance. Therefore, since the fluctuation of the output impedance of the power amplifiers 20 and 30 is suppressed against the fluctuation of the load impedance R_{ANT}, an antenna module 1 having stable output characteristics against load fluctuation can be provided.

Further, for example, in the antenna module 1, when a main surface of the patch antenna 10 is viewed in plan view, a first direction from a center Pc of the patch antenna 10 toward the feed point 101 is different from a second direction from the center Pc toward the feed point 102.

With such a configuration, by setting the phase difference between the first signal inputted to the feed point 101 and the second signal inputted to the feed point 102 to be 90°, the patch antenna 10 can have circularly polarized antenna characteristics.

Further, for example, in the antenna module 1, the phase of a high-frequency signal outputted from the power amplifier 20 at one end of the input-side coil 601 and the phase of a high-frequency signal outputted from the power amplifier 30 at the other end of the input-side coil 601 are opposite to each other.

Thus, the power amplifiers 20 and 30 become a differential amplifying-type amplifier circuit.

Further, for example, in the antenna module 1, the power amplifier 20 and the power amplifier 30 constitute a differential amplifying-type amplifier circuit.

Further, for example, in the antenna module 1, the phase of a high-frequency signal inputted to the feed point 101 is different from the phase of a high-frequency signal inputted to the feed point 102.

Further, for example, in the antenna module 1, the phase difference of high-frequency signals respectively inputted to the feed points 101 and 102 is 90°.

Further, for example, in the antenna module 1, the first direction is orthogonal to the second direction.

Thus, the patch antenna 10 can have circularly polarized antenna characteristics.

Further, for example, the antenna module 1A according to Modification 1 includes: a patch antenna 10; power amplifiers 20A and 30A; a transformer 60; ¼ wavelength transmission lines 70 and 80; input terminals 120 and 130; and a ¼ wavelength transmission line 80 connected between the output end of the power amplifier 30A and the other end of the input-side coil 601.

Thus, a high-efficiency antenna module 1A having a back-off amount and stable output characteristics against load fluctuation can be provided.

Further, for example, the antenna module 1B according to Modification 2 includes: a patch antenna 10A having feed points 101, 102, 103 and 104; power amplifiers 20, 30, 40 and 50; a transformer 60 having an input-side coil 601 and an output-side coil 602; a transformer 65 having an input-side coil 651 and an output-side coil 652; and ¼ wavelength transmission lines 70 and 75. An output end of the power amplifier 20 is connected to one end of the input-side coil 601, an output end of the power amplifier 30 is connected to the other end of the input-side coil 601, an output end of the output-side coil 602 is connected to the feed point 101, the other end of the output-side coil 602 is connected to one end of the ¼ wavelength transmission line 70, the other end of the ¼ wavelength transmission line 70 is connected to the feed point 102, an output end of the power amplifier 40 is connected to one end of the input-side coil 651, an output end of the power amplifier 50 is connected to the other end of the input-side coil 651, one end of the output-side coil 652 is connected to the feed point 103, the other end of the output-side coil 652 is connected to one end of the ¼ wavelength transmission line 75, and the other end of the ¼ wavelength transmission line 75 is connected to the feed point 104.

With such a configuration, since the transformers 60 and 65 and the ¼ wavelength transmission lines 70 and 75 are added, even if the load impedance R_{ANT} becomes high, the output impedance of the power amplifiers 20 to 50 becomes the averaged impedance, and even if the load impedance R_{ANT} becomes low, the output impedance of the power amplifiers 20 to 50 becomes the averaged impedance. In other words, since the fluctuation of the output impedance of the power amplifiers 20 to 50 is suppressed against the fluctuation of the load impedance R_{ANT}, an antenna module 1B having stable output characteristics against load fluctuation can be provided.

Further, for example, in the antenna module 1B, the phase of a high-frequency signal outputted from the power amplifier 20 at one end of the input-side coil 601 and the phase of a high-frequency signal outputted from the power amplifier 30 at the other end of the input-side coil 601 are opposite to each other, and the phase of a high-frequency signal outputted from the power amplifier 40 at one end of the input-side coil 651 and the phase of a high-frequency signal outputted from the power amplifier 50 at the other end of the input-side coil 651 are opposite to each other.

Thus, the power amplifiers 20 and 30 become a differential amplifying-type amplifier circuit, and the power amplifiers 40 and 50 become a differential amplifying-type amplifier circuit.

Further, for example, in the antenna module 1B, the power amplifier 40 and the power amplifier 50 constitute a differential amplifying-type amplifier circuit.

Further, for example, in the antenna module 1B, the phase of a high-frequency signal inputted to the feed point 101 is different from the phase of a high-frequency signal inputted to the feed point 102, the phase of the high-frequency signal inputted to the feed point 102 is different from the phase of a high-frequency signal inputted to the feed point 103, the phase of the high-frequency signal inputted to the feed point 103 is different from the phase of a high-frequency signal inputted to the feed point 104, and the phase of the high-frequency signal inputted to the feed point 104 is different from the phase of the high-frequency signal inputted to the feed point 101.

Further, for example, in the antenna module 1B, the phase difference of high-frequency signals respectively inputted to the feed points 101 and 102 is 90°, the phase difference of high-frequency signals respectively inputted to the feed points 102 and 103 is 90°, the phase difference of high-frequency signals respectively inputted to the feed points 103 and 104 is 90°, and the phase difference of high-frequency signals respectively inputted to the feed points 104 and 101 is 90°.

Further, for example, in the antenna module 1B, when a main surface of the patch antenna 10A is viewed in plan view, a first direction from a center Pc toward the feed point 101 is orthogonal to a second direction from the center Pc toward the feed point 102, the second direction is orthogonal to a third direction from the center Pc toward the feed point 103, the third direction is orthogonal to a fourth direction from the center Pc toward the feed point 104, the fourth direction is orthogonal to the first direction, the first direction is opposite to the third direction, and the second direction is opposite to the fourth direction.

Thus, the patch antenna 10A can have circularly polarized antenna characteristics.

Further, for example, the antenna module 1C according to Modification 3 includes: a patch antenna 10A; power amplifiers 20A, 30A, 40A and 50A; transformers 60 and 65; ¼ wavelength transmission lines 70 and 75; a ¼ wavelength transmission line 80 connected between an output end of the power amplifier 30A and the other end of an input-side coil 601, and a ¼ wavelength transmission line 85 connected between the output end of the power amplifier 50A and the other end of an input-side coil 651.

Thus, a high-efficiency antenna module 1C having a back-off amount and stable output characteristics against load fluctuation can be provided.

Further, the communication device 3 according to the present embodiment includes: a signal processing circuit 2 that processes a high-frequency signal; and the antenna module 1 connected to the signal processing circuit 2.

Thus, the effect of the antenna module 1 can be realized by the communication device 3.

### Other Embodiments

The antenna module and the communication device according to the present disclosure have been described above with reference to the embodiment and modifications; however, the antenna module and the communication device according to the present disclosure are not limited to the embodiment and modifications described above. The present disclosure also includes other embodiments realized by combining any of the components in the embodiment and modifications described above, modifications obtained by applying various modifications conceived by those skilled in the art to the embodiment and modifications described above without departing from the spirit of the present disclosure, and various devices incorporating the antenna module and the communication device described above.

For example, other circuit elements, wiring and/or the like may be inserted between the paths connecting each circuit element and signal path disclosed in the drawings in the circuit configuration of the antenna module and the communication device according to the embodiment described above.

The following are the features of the antenna module and the communication device described based on the above embodiment and modifications.

<1> An antenna module comprising: a patch antenna having a first feed point and a second feed point; a first power amplifier and a second power amplifier; a first transformer having a first input-side coil and a first output-side coil; and a first impedance conversion circuit, wherein an output end of the first power amplifier is connected to one end of the first input-side coil, an output end of the second power amplifier is connected to another end of the first input-side coil, one end of the first output-side coil is connected to the first feed point, another end of the first output-side coil is connected to one end of the first impedance conversion circuit, and another end of the first impedance conversion circuit is connected to the second feed point.

<2> The antenna module according to <1>, wherein, when a main surface of the antenna is viewed in plan view, a first direction from a center of the antenna toward the first feed point is different from a second direction from the center toward the second feed point.

<3> The antenna module according to <1> or <2>, wherein the first impedance conversion circuit is a ¼ wavelength transmission line.

<4> The antenna module according to any one of <1> to <3>, wherein a phase of a high-frequency signal outputted from the first power amplifier at one end of the first input-side coil and a phase of a high-frequency signal outputted from the second power amplifier at the other end of the first input-side coil are opposite to each other.

<5> The antenna module according to any one of <1> to <4>, wherein the first power amplifier and the second power amplifier constitute a differential amplifying-type amplifier circuit.

<6> The antenna module according to any one of <1> to <4>, wherein a phase of a high-frequency signal inputted to the first feed point is different from a phase of a high-frequency signal inputted to the second feed point.

<7> The antenna module according to any one of <1> to <6>, wherein a phase difference of high-frequency signals respectively inputted to the first feed point and the second feed point is 90°.

<8> The antenna module according to <2>, wherein the first direction is orthogonal to the second direction.

<9> The antenna module according to any one of <1> to <8>, further comprising: a first phase shifting circuit connected to only one of: between the output end of the second power amplifier and the other end of the first input-side coil, and between the output end of the first power amplifier and the one end of the first input-side coil.

<10> The antenna module according to any one of <1> to <9>, further comprising: a third power amplifier and a fourth power amplifier; a second transformer having a second input-side coil and a second output-side coil; and a second impedance conversion circuit, wherein the patch antenna further has a third feed point and a fourth feed point, an output end of the third power amplifier is connected to one end of the second input-side coil, an output end of the fourth power amplifier is connected to another end of the second input-side coil, one end of the second output-side coil is connected to the third feed point, another end of the second output-side coil is connected to one end of the second impedance conversion circuit, and another end of the second impedance conversion circuit is connected to the fourth feed point.

<11> The antenna module according to <10>, wherein the second impedance conversion circuit is a ¼ wavelength transmission line.

<12> The antenna module according to <10> or <11>, wherein a phase of a high-frequency signal outputted from the third power amplifier at one end of the second input-side coil and a phase of a high-frequency signal outputted from the fourth power amplifier at the other end of the second input-side coil are opposite to each other.

<13> The antenna module according to <10> or <11>, wherein the third power amplifier and the fourth power amplifier constitute a differential amplifying-type amplifier circuit.

<14> The antenna module according to any one of <10> to <13>, wherein a phase of a high-frequency signal inputted to the first feed point is different from a phase of a high-frequency signal inputted to the second feed point, the phase of the high-frequency signal inputted to the second feed point is different from a phase of a high-frequency signal inputted to the third feed point, the phase of the high-frequency signal inputted to the third feed point is different from a phase of a high-frequency signal inputted to the fourth feed point, and the phase of the high-frequency signal inputted to the fourth feed point is different from the phase of the high-frequency signal inputted to the first feed point.

<15> The antenna module according to <14>, wherein a phase difference of high-frequency signals respectively inputted to the first feed point and the second feed point is 90°, a phase difference of high-frequency signals respectively inputted to the second feed point and the third feed point is 90°, a phase difference of high-frequency signals respectively inputted to the third feed point and the fourth feed point is 90°, and a phase difference of high-frequency signals respectively inputted to the fourth feed point and the first feed point is 90°.

<16> The antenna module according to <15>, wherein, when a main surface of the antenna is viewed in plan view, a first direction from a center of the antenna toward the first feed point is orthogonal to a second direction from the center toward the second feed point, the second direction is orthogonal to a third direction from the center toward the third feed point, the third direction is orthogonal to a fourth direction from the center toward the fourth feed point, the fourth direction is orthogonal to the first direction, and the first direction is opposite to the third direction, and the second direction is opposite to the fourth direction.

<17> The antenna module according to any one of <10> to <16>, further comprising: a second phase shifting circuit connected to only one of: between the output end of the fourth power amplifier and the other end of the second input-side coil, and between the output end of the third power amplifier and the one end of the second input-side coil.

<18> A communication device comprising: a signal processing circuit that processes a high-frequency signal; and the antenna module according to any one of <1> to <17> connected to the signal processing circuit.

The present disclosure, as an antenna module or a communication device arranged in a multi-band adaptive front-end section, can be widely used in communication apparatuses such as cellular phones.
1, 1A, 1B, 1C, 500 antenna module
2 signal processing circuit
3 communication device
10, 10A patch antenna
11 dielectric substrate
12 radiation conductor
13 ground conductor
20, 20A, 30, 30A, 40, 40A, 50, 50A power amplifier
60, 65 transformer
61 end portion
70, 75, 80, 85 ¼ wavelength transmission line
101, 102, 103, 104 feed point
120, 130, 140, 150 input terminal
601, 651 input-side coil
602, 652 output-side coil
Pc center

1. An antenna module comprising:
an antenna having a first feed point and a second feed point;
a first power amplifier and a second power amplifier;
a first transformer having a first input-side coil and a first output-side coil; and
a first impedance conversion circuit,
wherein an output end of the first power amplifier is connected to a first end of the first input-side coil,
wherein an output end of the second power amplifier is connected to a second end of the first input-side coil,
wherein a first end of the first output-side coil is connected to the first feed point,
wherein a second end of the first output-side coil is connected to a first end of the first impedance conversion circuit, and
wherein a second end of the first impedance conversion circuit is connected to the second feed point.

2. The antenna module according to claim 1, wherein in a plan view of a main surface of the antenna, a first direction from a center of the antenna toward the first feed point is different from a second direction from the center toward the second feed point.

3. The antenna module according to claim 1, wherein the first impedance conversion circuit is a ¼ wavelength transmission line.

4. The antenna module according to claim 1, wherein a phase of a high-frequency signal outputted from the first power amplifier at the first end of the first input-side coil and a phase of a high-frequency signal outputted from the second power amplifier at the second end of the first input-side coil are opposite to each other.

5. The antenna module according to claim 1, wherein the first power amplifier and the second power amplifier constitute a differential amplifying-type amplifier circuit.

6. The antenna module according to claim 1, wherein a phase of a high-frequency signal inputted to the first feed point is different from a phase of a high-frequency signal inputted to the second feed point.

7. The antenna module according to claim 1, wherein a phase difference of high-frequency signals respectively inputted to the first feed point and the second feed point is 90°.

8. The antenna module according to claim 2, wherein the first direction is orthogonal to the second direction.

9. The antenna module according to claim 1, further comprising:
a first phase shifting circuit connected only to one of: a node between the output end of the second power amplifier and the second end of the first input-side coil, or a node between the output end of the first power amplifier and the second end of the first input-side coil.

10. The antenna module according to claim 1, further comprising:
a third power amplifier and a fourth power amplifier;
a second transformer having a second input-side coil and a second output-side coil; and
a second impedance conversion circuit,
wherein the antenna further has a third feed point and a fourth feed point,
wherein an output end of the third power amplifier is connected to a first end of the second input-side coil,
an output end of the fourth power amplifier is connected to a second end of the second input-side coil,
wherein a first end of the second output-side coil is connected to the third feed point,
wherein a second end of the second output-side coil is connected to a first end of the second impedance conversion circuit, and
wherein a second end of the second impedance conversion circuit is connected to the fourth feed point.

11. The antenna module according to claim 10, wherein the second impedance conversion circuit is a ¼ wavelength transmission line.

12. The antenna module according to claim 10, wherein a phase of a high-frequency signal outputted from the third power amplifier at the first end of the second input-side coil and a phase of a high-frequency signal outputted from the fourth power amplifier at the second end of the second input-side coil are opposite to each other.

13. The antenna module according to claim 10, wherein the third power amplifier and the fourth power amplifier constitute a differential amplifying-type amplifier circuit.

14. The antenna module according to claim 10,
wherein a phase of a high-frequency signal inputted to the first feed point is different from a phase of a high-frequency signal inputted to the second feed point,
wherein the phase of the high-frequency signal inputted to the second feed point is different from a phase of a high-frequency signal inputted to the third feed point,
wherein the phase of the high-frequency signal inputted to the third feed point is different from a phase of a high-frequency signal inputted to the fourth feed point, and
wherein the phase of the high-frequency signal inputted to the fourth feed point is different from the phase of the high-frequency signal inputted to the first feed point.

15. The antenna module according to claim 14,
wherein a phase difference of high-frequency signals respectively inputted to the first feed point and the second feed point is 90°,
wherein a phase difference of high-frequency signals respectively inputted to the second feed point and the third feed point is 90°,
wherein a phase difference of high-frequency signals respectively inputted to the third feed point and the fourth feed point is 90°, and
wherein a phase difference of high-frequency signals respectively inputted to the fourth feed point and the first feed point is 90°.

16. The antenna module according to claim 15, wherein in a plan view of a main surface of the antenna:
a first direction from a center of the antenna toward the first feed point is orthogonal to a second direction from the center toward the second feed point,
the second direction is orthogonal to a third direction from the center toward the third feed point,
the third direction is orthogonal to a fourth direction from the center toward the fourth feed point,
the fourth direction is orthogonal to the first direction, and
the first direction is opposite to the third direction, and the second direction is opposite to the fourth direction.

17. The antenna module according to claim 10, further comprising:
a second phase shifting circuit connected only to one of: a node between the output end of the fourth power amplifier and the second end of the second input-side coil, or a node between the output end of the third power amplifier and the second end of the second input-side coil.

18. A communication device comprising:
a signal processing circuit configured to process a high-frequency signal; and
the antenna module according to claim 1 connected to the signal processing circuit.
